(19) United States
(12) Patent Application Publication
(10) Pub. No.: US 2019/0366377 A1
(43) Pub. Date: Dec. 5, 2019

(54) METHOD FOR PROTECTING AN ADHESIVE DELIVERY APPARATUS, AND THIS SAME

(71) Applicant: Illinois Tool Works Inc., Glenview, IL (US)

(72) Inventor: Andreas Pahl, Erkrath (DE)

(21) Appl. No.: 16/349,375

(22) PCT Filed: Nov. 10, 2017
(86) PCT No.: PCT/US17/61035

§ 371 Date: May 13, 2019

(30) Foreign Application Priority Data
Nov. 28, 2016 (DE) 10 2016 014 092.5

(51) Int. Cl. B05B 15/50; B05B 7/24; B05B 7/16; B05C 5/02

(52) U.S. Cl. CPC B05B 15/50; B05C 5/027; B05B 7/164; B05B 7/2491

(57) ABSTRACT

A method for protecting an adhesive delivery apparatus (10) having an adhesive outlet opening (16) through which adhesive can be extracted from the adhesive delivery apparatus (10), in particular toward a surface (13) which is to be wetted with the adhesive, which comprises feeding of an air moisture protection gas (41) into the region of the adhesive outlet opening (16), is described and represented.

The invention relates, according to a first aspect, to a method for protecting an adhesive delivery apparatus. The adhesive delivery apparatus herein typically has an adhesive outlet opening, through which the adhesive can be extracted from the adhesive delivery apparatus. The adhesive can be discharged, preferably in a spraying manner, toward a surface, for instance a substrate or a component from the automotive industry, which is to be wetted with the adhesive. In such processes, adhesives which in their use or application react with air moisture and hereby have particularly highly adhesive, but also environmentally friendly properties, are mainly used.

That which is advantageous for the lamination process causes maintenance-related difficulties, however, since in practice it is shown that the adhesive is typically not fully discharged from the adhesive delivery apparatus, but instead at least a remnant of adhesive remains in the adhesive outlet opening.

In the case of a production stoppage or a pause in production or change in production or similar, the remaining adhesive then typically continues to react in the adhesive outlet opening with the air moisture of the ambient air and may possibly clog the adhesive outlet opening or the nozzle (and thus the adhesive delivery apparatus as a whole).

Even though such problems do not always lead to a complete blockage of the delivery nozzle, they do, however, frequently impair the delivery pattern when production is restarted.

For the prevention of this problem, some possible solutions which are not supportable by documentary evidence are known from the prior art: Thus the adhesive delivery apparatus with its spray nozzle is mounted, for instance, completely in an oil bath. Alternatively, the nozzles (comprising the adhesive outlet opening) can also merely be extracted from the adhesive delivery apparatus and stored separately in an oil bath (while the adhesive delivery apparatus is closed off with a dummy plate or dummy nozzle or similar).

An alternative option from the prior art consists in “flushing” the entire adhesive delivery apparatus at predefined intervals, including during a pause in production, with fresh adhesive or special cleaners. This last option is very labor intensive and material intensive.

All known solutions thus exhibit significant drawbacks, not least a prolongation of the switch-off times of the apparatus (since, for instance, the nozzles must be cleaned after their oil bath and/or separately mounted).

Accordingly, the object of the present invention consists in providing a method for protecting corresponding adhesive delivery apparatuses from blockage in a still simpler manner.

The invention achieves the stated object firstly with the features of claim 1 and is accordingly characterized by feeding of an air moisture protection gas into the region of the adhesive outlet opening.

In other words, the idea of the invention consists in employing dry gas, preferably as spray air, in order to protect the adhesive outlet opening from (air) moisture, in particular (including) during a pause in production.

The air moisture protection gas can thus encompass the adhesive outlet opening in the manner of a curtain or a blanket and flow continuously there. As a result of this flow curtain, the air moisture of the atmosphere surrounding the delivery apparatus cannot then make its way to or into the adhesive outlet opening.

In this context, it is naturally of importance, in preferred form, also that the air moisture protection gas itself has no or virtually no air moisture.

Normal air or compressed air is in this sense therefore, in its conventional form, unsuitable as a protective gas, since it itself contains an air moisture content which substantially corresponds to that of the ambient atmosphere. The air moisture protection gas should therefore, in particular, have no water vapor at all, or an only very small water vapor component (at any rate, in comparison with the ambient atmosphere). In particular, a water vapor-free gas should be used. (Virtually) water vapor-free air is herein referred to, in particular, as dry air.

In its simplest form, the air moisture protection gas can here consist of dry air, which air, in particular, can be dried with the adhesive delivery apparatus (an air dryer can in this case therefore be arranged at the production site of the user or, at any rate, close to the adhesive outlet opening, for instance at a distance of less than a few meters, for instance less than 1 km, advantageously less than 200 m, advantageously less than 50 m, further advantageously less than 10 m distance from the adhesive outlet opening). This has the advantage that, in essence, normal or conventional air or compressed air can be used, which is then dried and is employed as protective gas.

Hence no supply of dried air has to be stocked. Rather, conventional (compressed) air can be utilized and actively dried. An active drying step can thus be an integral method step of the claimed method. Accordingly, air or compressed air is dried in a method step. This will take place according to the invention prior to feeding of the dried air into the region of the adhesive outlet opening, in particular shortly before (for instance just a few moments or seconds or minutes before).

For the drying of the air, various options are here available, such as, for instance, a cooling and/or compression of the air or the execution of a diffusion process (for instance with the aid of a membrane dryer) or an adhesion process. In all said cases, water is constantly separated from the air as a condensate and the air is thus converted into dried air or dry air.

Alternatively, the utilization of another suitable, in particular dry gas is also possible, however. This gas should therefore have only a very small (or nil) water or H₂O component. In particular, pure gases or inert gases are therefore particularly suitable.

According to the invention, the air moisture protection gas is conducted into the region of the region of the adhesive outlet opening. This means, in particular, that the protective gas outwardly surrounds or shields the adhesive outlet opening. The protective gas can be fed to the region of the adhesive outlet opening, hence in particular from outside the adhesive outlet opening. In principle, it is alternatively also possible, however, to connect the protective gas fluidically upstream of the adhesive outlet opening and thus to feed the protective gas to the adhesive before it leaves the adhesive outlet opening (i.e. in the adhesive outlet duct). In this case, the adhesive and the protective gas would then jointly leave the adhesive outlet opening.

The alternative in which the air moisture protection gas is assigned to a separate protective gas outlet (or a plurality thereof), which is configured separate from the adhesive outlet opening, yet preferably in the vicinity thereof, has proved particularly advantageous, however. In particular, in the region of the adhesive outlet opening, one or more protective gas outlet openings can be arranged.

Since corresponding adhesives are typically delivered in a spraying manner, the adhesive delivery apparatus is in the most preferred embodiment also configured as a spraying device. In such a configuration, a spraying medium carries the adhesive toward the surface to be wetted. According to the invention, it can herein be provided that the air moisture protection gas forms precisely this spraying medium, or that the air moisture protection gas is used as the spraying medium.

This configuration has the advantage that conventional adhesive delivery apparatuses can actually readily (or without substantial modification) continue to be used. Instead of a conventional spraying medium (typically unmodified, moist compressed air), the adhesive delivery apparatus can henceforth be fed an air moisture protection gas, which can flow through the pre-existing spraying medium lines and be conducted as standard spray air into the region of the adhesive outlet opening.

The term “air moisture protection gas” means within the meaning of the present invention that the gas protects the adhesive outlet opening in particular from the external penetration of air moisture (the environment). In particular, the term can however also be interpreted such that, alternatively or additionally, the protective gas itself has no, or only a very small air moisture component, so that, also by virtue of the protective gas itself, there is no threat of a reaction with the adhesive which would lead to clogging of the adhesive delivery apparatus or its nozzle.

Merely for the sake of completeness, it should be noted that the invention is also, however, intended to embrace methods or apparatuses which use air moisture protection gas in addition to normal spray air. To this end, additional lines separated from the spray air can be assigned to the air moisture protection gas.

In this context, it is also conceivable that the air moisture protection gas and the spray air are delivered alternately. Thus, in one illustrative embodiment, spray air could be delivered when the adhesive delivery apparatus is active and adhesive is due to be delivered. During a pause in production, a switch could then be made to the delivery of air moisture protection gas.

As already indicated above, it appears most advantageous, however, to directly employ the air moisture protection gas as the spraying medium.

An inventive protection of the adhesive delivery apparatus can (herein) be achieved by virtue of the fact that the adhesive delivery apparatus, including in the case of a pause in production (or in the event that precisely no adhesive is delivered), conducts air moisture protection gas into the region of the adhesive outlet opening. By the protective gas curtain which is thus formed, the adhesive delivery apparatus can be effectively protected, since substantially no air moisture makes its way from outside (through the curtain) to the adhesive outlet opening, where it could then react with adhesive.

In summary, in this preferred embodiment therefore, for the protection of the apparatus, air moisture protection gas, (including) during a pause in production, needs merely to be conducted into said region. A removal or an immersion in oil of the nozzle, or the whole of the adhesive delivery apparatus, is hence unnecessary. In principle, the apparatus can, of course, additionally be flushed with a cleaner.

The adhesive delivery apparatus is in particular suitable for transporting an adhesive toward a surface to be wetted. For this, as already described, a spraying medium, in particular the air moisture protection gas, is typically used. In this way, a spraying impingement of the surface can be achieved, the adhesive preferably being delivered in filament shape. Alternatively, also a droplet form or any other possible form of delivery is also, in essence, embraced by the invention.

When it is present in filament shape, the adhesive can be converted by the spraying medium, for instance, into a known, alternating, meandering shape, in particular transversely to the transport direction of the surface to be wetted.

The surface can herein be led past beneath the adhesive outlet opening. Alternatively, the adhesive outlet opening can be guided over the surface (for instance with the aid of a robot arm or similar). In this context, merely a relative movement of adhesive outlet opening and surface to be wetted is crucial. The surface is typically constituted by laminar substrate portions or substrates which are usually to be evenly wetted. It can in particular be a case of substantially smooth (and/or convex) surfaces (without hollows or similar).

A typical adhesive in which the protection method according to the invention can be used particularly advantageously is so-called “hot-melt” adhesive. A reactive hot-melt adhesive of this type can be based, for instance, on polyurethanes and can react with air moisture, during use or application, to form a crosslinked polyurethane with high molar mass.

Reactive hot-melt adhesives of this type solidify during cooling and hereby allow fast production and bonding processes, in particular without prior drying of the adhesive.

An apparatus which can apply a hot-melt adhesive in a spraying manner can also be termed a melt blowing apparatus, a corresponding method as melt blowing.

The adhesive delivery apparatus can, of course, have more than just one adhesive outlet opening. Typically, such a delivery apparatus has a multiplicity of adhesive outlet openings (in particular arranged in a row or line). To each adhesive outlet opening is here typically assigned a nozzle or a valve, which latter can be closable and openable, for instance, with a needle. Alternatively, a plurality of adhesive outlet openings can here be assigned, of course, to a nozzle (with a valve).

According to a particularly preferred embodiment of the invention, the method for the protection relates to an adhesive delivery apparatus for adhesives of a type which hardens with the addition of air moisture. In this case, the invention—as just described—can be used especially advantageously, since, in such an adhesive type, the adhesive outlet opening or the delivery apparatus is particularly at risk of blockage. However, the method according to the invention can also be used in respect of other adhesives, since protection of the adhesive outlet opening from moisture is fundamentally desirable.

According to the most preferred embodiment of the invention, the adhesive delivery apparatus is configured as a spraying apparatus, for the spraying delivery of the adhesive, with the use of a spraying medium, wherein the air moisture protection gas is used as the spraying medium. In this embodiment of the invention, preferably no separate spraying medium is therefore provided. Rather, the air moisture protection gas can be employed for this. Consequently, also just one gas feed line needs to be provided for the delivery apparatus, namely that for the protective gas. A separate spraying medium line is not necessary. Rather, the existing line is employed specifically to conduct the protective gas, which serves, as it were, as the spraying medium.

Advantageously, as the air moisture protection gas dried air is used. This has the advantage that conventional compressed air which in corresponding delivery apparatuses is anyhow used as spraying medium (and for which feed lines are often already present) can easily continue to be used, namely as protective gas.

Conventional compressed air herein requires, however, a prior modification or treatment. The air must namely be dried. Water thus has to be extracted from the air. Air which has been modified in this way is also referred to as dry air or dried air. Its water component is non-existent or virtually non-existent. Dried air (or the protective gas) advantageously has substantially no water component any more.

For this, the adhesive delivery apparatus can have, for instance, an air drying unit, or a corresponding unit can be assigned thereto. This unit can then be connected by a line, for instance, to an adhesive delivery nozzle (or more than one such) of the apparatus.

Alternatively, the use of another dry gas, i.e. a gas which contains no water or only very little water, is also possible, however.

In principle, a so-called inert gas, i.e. a gas which has substantially low reactivity and which therefore is not inclined to react with the employed adhesive, can also be used as the air moisture protection gas. Depending on the employed adhesive, a suitable gas, in particular an inert gas, can be selected and used.

If dried air or dry air is used as the air moisture protection gas, then conventional air or conventional compressed air can advantageously be conducted through a membrane air dryer and in this way dried. The membrane air dryer can be a component of the adhesive delivery apparatus, or can be assigned thereto or connected upstream thereof, for instance via a line. The membrane air dryer thus enables a very simple modification of a conventional adhesive delivery apparatus, such that this does not have to redesigned or reconstructed. Rather a membrane air dryer can be easily connected up to a conventional adhesive delivery apparatus in order to improve the functionality thereof.

Membrane air dryers generally work via diffusion. An appropriate dryer can consist, for instance, of a large number of hollow fibers arranged in parallel in the longitudinal direction. When the as yet undried air flows through these fibers in the longitudinal direction, the water of the air can penetrate the side walls thereof more quickly than the remaining components of the air. With the aid of already dried air which has passed through the same dryer, with an air current (drying current) drier air can be ensured outside the fibers than within the fibers. This differential leads to a diffusion of the water from the inside of the fiber to the outside of the fiber. There the moist spray air can then be led off into the open, so that dried air can leave the membrane air dryer in the direction of conduction.

Instead of a membrane air dryer, any other suitable dryer can however also, of course, be used, for instance an absorption dryer which works according to the principle of adhesion, or similar.

Advantageously, one or more filter stages are herein assigned to or connected upstream of the air dryer. These filter stages can ensure that the air fed to the air dryer can be substantially cleaned of particles and oil. In particular, a plurality of filter stages of different passage size can be provided.

According to a particularly advantageous method, it is provided that the air moisture protection gas is (also) fed to the region of the adhesive outlet opening when no adhesive is extracted from the adhesive delivery apparatus. This idea can be seen as independent of whether the air moisture protection gas also provides the spraying medium or not.

In both cases, it is important that during a pause in production, for example, the adhesive outlet opening is protected. In this sense, it is advantageously provided, however, that the air moisture protection gas is also fed to the region of the adhesive outlet opening when adhesive is extracted from the adhesive delivery apparatus (for example during the production process).

In such a case, it is particularly advantageous if the inflow rate of air moisture protection gas into the region of the adhesive outlet opening is switchable. For instance, the inflow rate can be throttled if precisely no adhesive is extracted (pause in production). The throttling can be retracted once the pause in production is ended and adhesive is due to be discharged again (in this case, the air moisture protection gas is then typically also utilized as a spraying or carrier medium). For the throttling, a valve, in particular a proportional valve, can, for instance, be used.

According to a particularly advantageous method according to the invention, it is provided that the air moisture protection gas is conducted into the region of the adhesive outlet opening at an angular offset to the principal direction of delivery of the adhesive. In this way, a particularly effective protection can be obtained, since the protective gas, in the event of such a feed, can form a particularly effective protective curtain or a protective hood.

Advantageously, an angular offset herein obtains such that the principal direction of delivery of the adhesive and the direction of delivery of the protective gas converge and meet, preferably at an acute angle. In other words, the angular offset is provided such that the protective gas is fed to the principal axis of delivery of the adhesive, and hence the protective gas is delivered in the direction of the delivered adhesive.

Advantageously, to the adhesive outlet opening are assigned a plurality of, namely at least two, air moisture protection gas outlet openings, for instance one on each side of the adhesive outlet opening. In this case, the three openings can then therefore be arranged in a row or in a line, preferably also with further, other outlet openings of further nozzles.

The principal direction of delivery of the adhesive is here typically defined by the orientation of the adhesive outlet opening. Typically, the principal direction of delivery points orthogonally away from the plane of extent of the adhesive outlet opening (toward the surface to be wetted).

According to a particularly advantageous embodiment of the method according to the invention, it is provided that the air moisture protection gas is conducted into the region of the adhesive outlet opening in such a way that, around the adhesive outlet opening, a dry protective gas curtain is formed, or a dry, substantially moisture-free protective gas blanket (dry means in this sense—as already indicated above—thus substantially free of moisture or virtually free of moisture).

An intake or feed of this type can be achieved, for instance, by the angular offset described above. Advantageously, it is herein provided that the protective gas is conducted into the region from at least two directions, which can be arranged, in particular, in mirror symmetry. The pressure of the emerging protective gas can herein keep the moisture of the ambient atmosphere away from the adhesive outlet opening.

A further aspect of the present invention relates to an adhesive delivery apparatus to be protected with the described method. The object of providing an apparatus which requires a particularly low maintenance effort is achieved, according to this aspect, with an adhesive delivery apparatus according to patent claim 10. The delivery apparatus is here, in particular, characterized in that it has an air moisture protection gas feed line into the region of the adhesive outlet opening.

In an apparatus of this type, in particular the preceding method according to the invention can thus be used.

With respect to the adhesive delivery apparatus according to patent claim 10, it is pointed out that the embodiments and advantages described in connection with the preceding method claims 1 to 9 should be deemed to have been disclosed also in connection with this apparatus. Thus, merely for reasons of clarity of the Application, repetitions of all the abovementioned illustrative embodiments and advantages are at this point dispensed with.

Of course, according to the apparatus claim, the adhesive delivery apparatus according to the invention can however also be constituted, for instance, by a spraying apparatus or hot melt blowing apparatus, in particular for (with the addition of air moisture) curing adhesives. Furthermore, the embodiments described above are intended to apply to the air moisture protection gas or the used adhesive and it should be noted that a corresponding apparatus can, of course, have a (throttle) circuit for the air moisture protection gas and have an angular offset orientation of the corresponding delivery ducts. Merely for the sake of completeness, it should be pointed out that the adhesive delivery apparatus can also, of course, have an appropriate air dryer, in particular a membrane air dryer. This can be integrated, for instance, in the main body of the delivery apparatus or can be modularly assigned to said main body via a line, wherein the air dryer too should belong to the delivery apparatus, even if it is not integrated in a main housing.

A membrane air dryer should also be disclosed and claimed independently as a modular component, having a connector for the transmission of the dried air into the region of the adhesive outlet opening.

Further advantages and embodiments of the invention emerge from the non-cited subclaims and from the now following description of the figures, in which:

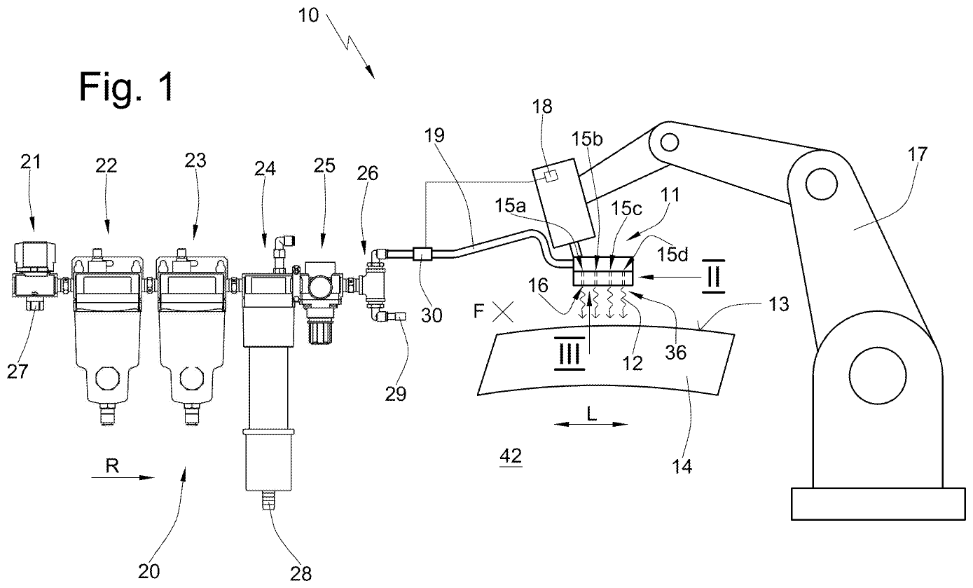

FIG. 1 shows in a very schematic, non-true-to-size basic representation a schematic side view of an apparatus according to the invention, with implementation of the method according to the invention, said apparatus having, by way of example, four adhesive delivery nozzles, wherein these are assigned to a robot arm and wherein these are connected for supply purposes to a membrane air dryer, which, for the sake of clarity, is shown in strongly enlarged representation, and wherein the gas is not represented,

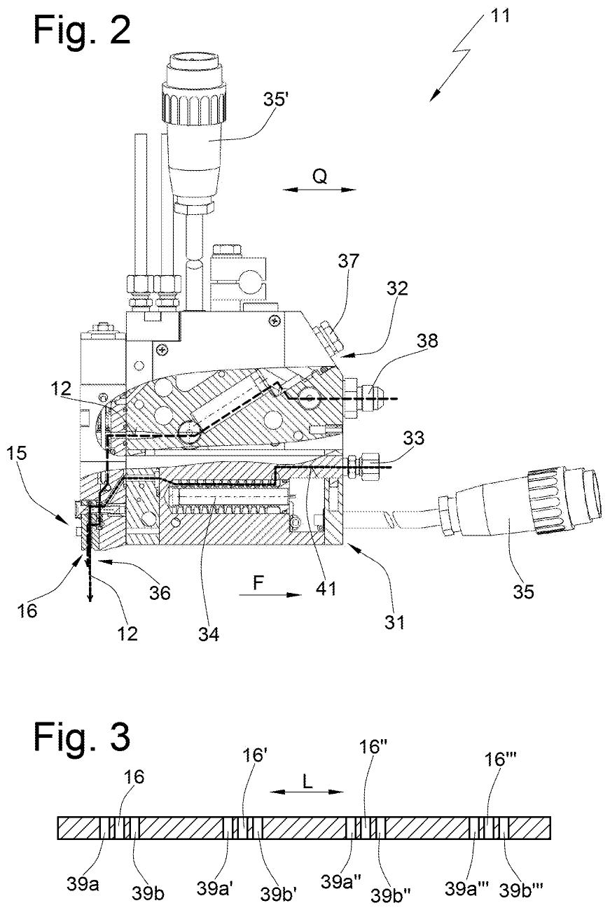

FIG. 2 shows a very schematic, partially sectioned side view of a delivery module of the delivery apparatus according to the invention, roughly along the view arrow II in FIG. 1,

FIG. 3 shows a very schematic bottom view for representing the adhesive outlet openings and the spraying medium outlet openings of the nozzle head represented in FIG. 1, approximately in a bottom view according to the view arrow III in FIG. 1, wherein FIG. 3 explicitly shows only one detail,

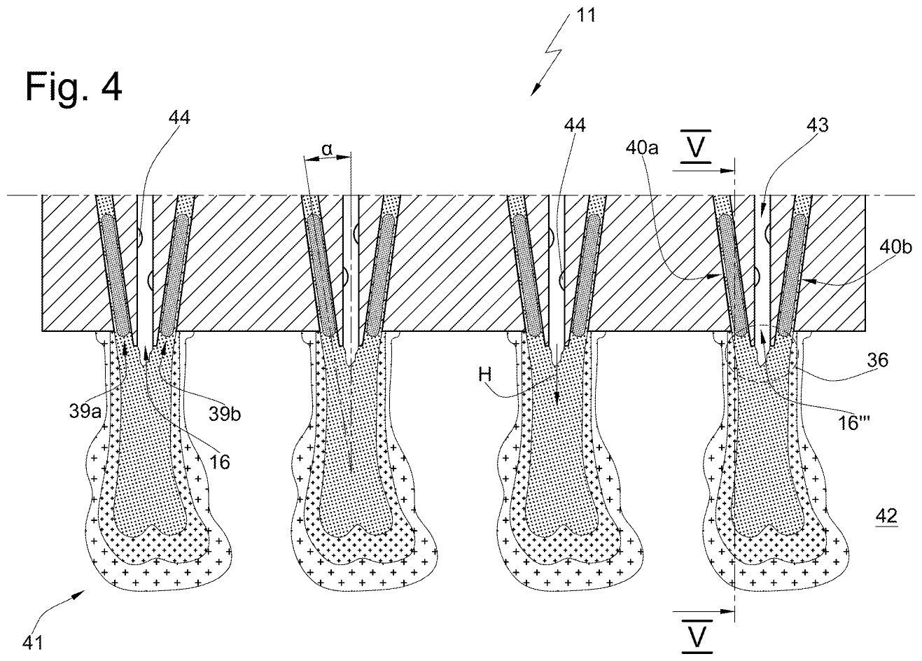

FIG. 4 shows a very schematic sectional view through the nozzle head represented in FIG. 1, with representation of the respective adhesive outlet openings and of the spraying medium outlet openings, wherein in FIG. 4, by way of example, the velocity ranges of the emerging spraying medium are provided with different hatchings or markings, and

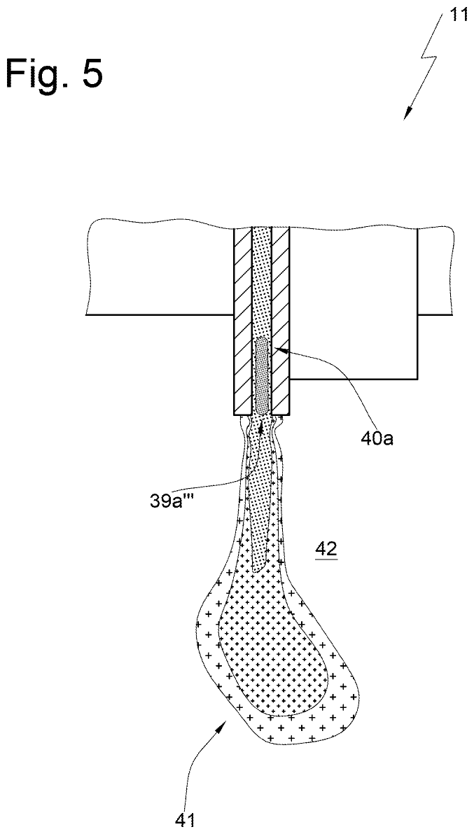

FIG. 5 shows in a likewise very schematic sectional view, roughly according to the view arrow V in FIG. 4, a cross section through one of the there represented nozzles of the nozzle head, with the same type of representation of the spraying medium velocities.

As a preface to the following description of the figures, it should be stated that same or comparable parts are provided, where appropriate, with identical reference symbols, sometimes with the addition of small letters or apostrophes as a suffix. In the patent claims which follow the description of the figures, the reference symbols employed in the figures and in the description of the figures may therefore (sometimes) be employed, for the sake of simplicity, without apostrophes or small letters, insofar as the corresponding objects are comparable.

FIG. 1 shows firstly an adhesive delivery apparatus 10 according to the invention in a very schematic side view, wherein the size relationships have been adapted or altered for the sake of clarity.

The represented adhesive delivery apparatus 10 here comprises an application head 11, which is guided over a surface 13, which is to be provided with adhesive 12, of a workpiece 14, for instance in the transport direction F, i.e., in respect of FIG. 1, into the plane of the figure.

The workpiece 14 can be constituted, for instance, by a workpiece of the automotive industry, for instance a body part of an automobile, or similar. The adhesive 12 is here applied substantially over the whole of the surface 13, in particular with the aid of spraying medium, which likewise emerges from the application head 11, but is not represented in FIG. 1. In the represented illustrative embodiment, this spraying medium causes the four exemplary adhesive filaments to have a substantially (in the plane) meandering shape.

The four adhesive filaments are here delivered from four exemplary nozzles 15a, 15b, 15c, 15d of the application head 11, for which purpose these in particular respectively have an adhesive outlet opening 16 (merely indicated in FIG. 1). In principle, each nozzle 15 can alternatively, however, also have, of course, a plurality of adhesive outlet openings 16.

The discharged adhesive 12 can typically be constituted by a so-called hot-melt adhesive, which in particular can have a polyurethane base, and in particular, as a result of a reaction with the air moisture of the atmospheric air 42 surrounding the workpiece 14, can react and harden. Before or at the same time, a further counter workpiece is typically, however, assigned to the workpiece 14 or the surface 13 and bonded thereto.

In the represented illustrative embodiment, the application head 11 is moved over the surface 13 in the transport direction F by a holding device 17, which in the illustrative embodiment is configured as a robot arm. This should be construed as merely illustrative. In principle, the holding device could also be configured as a stationary holding device, such as a bridge or similar, and the workpiece 14 could be guided along the application head 11 (for example with the aid of a conveyor belt).

In said illustrative embodiment according to FIG. 1, the application head 11 is connected via a connection (not represented) to a control device 18. The latter can be assigned, for instance, to the holding device 17, wherein the control device 18 can regulate the controlling of the application head 11, for example the opening times of the nozzles, the desired outlet quantities of adhesive, and similar. In principle, the control device 18 can however also be utilized to control the relative movement between surface 13 and application head 11, for instance by controlling the holding device 17 and/or a conveyor for the workpiece 14.

In the illustrative embodiment, the positioning of the control device 18 should likewise be construed as merely illustrative. In principle, the control device 18 could also be arranged further remote from the application head 11 and be configured, for instance, as a stationary computer, which, via a wireless or wired connection, can transmit information to the application head 11 and/or the holding device 17.

Moreover, the application head 11 is connected via a gas line 19, which can be constituted, for instance, by a hose or similar, to an air dryer 20. The running of the gas line 19 should here be construed as merely schematic. In practice, the line 19 would actually more likely be laid on the mounting 17 along to the head 11.

The air dryer 20 herein substantially comprises (viewed in the direction of flow) an inlet valve 21, a first filter 22, a second filter 23, a membrane dryer 24, a regulating element 25 and a connector 26.

The inlet valve 21 here has, for instance, a connector 27, by means of which the air dryer 20 can be connected in a non-represented manner to a standard compressed air connection. In this way, compressed air can thus make its way into the air dryer 20. This compressed air can in the first filter 22 firstly be cleaned of coarse impurities, such as, for instance, dirt particles or oil particles.

A finer filtering of the compressed air can subsequently take place in the second filter 23, which typically has a still finer filter element. The actual drying of the compressed air then takes place in the membrane air dryer element 24, which comprises the actual membrane. This membrane here consists of a large number of hollow fibers lying parallel to one another in the longitudinal direction, which in FIG. 1, however, are not represented, but are arranged within the element 24. Moisture can easily pass through these hollow fibers, yet the remaining compressed air components cannot readily do so. The moisture of the compressed air is here induced according to known principles to pass through the filter and can then leave the element 24 at a moisture or water connection 28 in a manner which is not represented in detail.

The dried air or dry air can then make its way in the direction of flow R through a regulating element 25 (with which, for instance, a stopcock-like turn-off can be realized) into the connector 26, which in the present illustrative embodiment is configured, for instance, as a T-piece. While the lower T-piece outlet is provided with a plug 29 (for potential further connections), to the upper outlet of the T-piece 26 is connected the aforementioned gas line 19.

Advantageously, between the air dryer 20 and the application head 11 is arranged a further valve 30, which in particular is configured as a proportional valve. This can adjust the transmission of dried air, for instance between at least two different flow rates. This proportional valve 30 too can preferably be connected to the control device 18.

In summary, in respect of FIG. 1, it can thus be established that, via the line 19 in the air dryer 20, dried, previously conventional, compressed air (in particular in two different states due to the valve 30) can be conducted to the application head 11.

This application head 11 is in FIG. 2 represented in a partially sectioned, very schematic side view, which substantially corresponds to the view arrow II in FIG. 1.

In FIG. 2, firstly no meandering of the discharged adhesive filament 12 is discernible, so that that meandering characteristic of the filaments 12 which is represented in FIG. 1 extends principally onto a plane running transversely to the actual transport direction F.

It can further be seen from the view according to FIG. 2 that the application head 11, in the plane represented, is constructed such that it is substantially divided into three parts: Thus, to the adhesive outlet 16 is firstly assigned a discharge nozzle 15 (left-hand region in respect of FIG. 2), while in the lower region is connected an air or gas block 31, above which an adhesive block 32 is in this case provided.

The gas block 31 firstly has a gas connector 33, via which the dried compressed air which is fed to the application head 11 via the line 19 can make its way into the gas block 31. In order to heat the dry air or keep it warm, in the gas block 31 is provided a heating unit 34, which is supplied with current via an electrical connection 35. It is here important to keep the gas 41 warm or heat it, since the adhesive in question is a hot-melt adhesive, which, when entering into contact with the gas (typically outside the adhesive outlet 16), must not be allowed to abruptly cool. The dry air 41 can hereupon make its way via the dashed path, for instance, into the region 36 of the nozzle 15 and can there be discharged via a separate opening (not shown in FIG. 2 due to the sectional representation) and fed to the region 36 of the adhesive outlet opening 16.

The adhesive block 32 then likewise provides an electrical connection 35′ for a heating element (not specifically labeled) in the adhesive block 32, whereby the hot-melt adhesive, of course, shall be kept warm. In addition, an (exchangeable) filter element 37 for the hot-melt adhesive is provided, and, of course, an adhesive connector 38, by which the adhesive (which is advanced to the application head 11 in a manner not represented in detail, for instance with the aid of a line or similar,) is connected up to the adhesive block 32.

The adhesive 12 can then run through the adhesive block 32 along the dashed path and so make its way to the nozzle 15 or the adhesive outlet 16 and emerges there under pressure.

If the adhesive 12 passes out of the adhesive outlet 16, it is carried by the dried compressed air 41, which is employed as a spraying fluid, onto the surface 13 represented in FIG. 1.

In order that that meandering shape of the adhesive filaments which is evident in FIG. 1 can be formed, to each adhesive outlet opening 16 can be assigned, in particular, a plurality of, namely in the present illustrative embodiment two, protective gas outlet openings 39. This is illustrated by FIG. 3.

FIG. 3 here represents a segmental, linear bottom view of the application head 11, in particular in relation to the four adhesive outlets 16 of the application head 11. The application head 11 can here be of four-part configuration and consist of four modules which are arranged side by side in the longitudinal direction L and which respectively have a cross section as represented in FIG. 2.

Thus each of these modules here has, according to FIG. 3, a central adhesive outlet 16 and two flanking protective gas outlet openings 39. Because two protective gas outlet openings 39 are assigned to the adhesive outlet 16 substantially symmetrically, the alternating filament is able to be achieved. In this case, the filament shape generally adjusts itself automatically, since typically an air blast firstly deflects the filament on one side and, by virtue of the two lateral air outlets, a steady state or a swinging back and forth is then achieved.

The two protective gas outlet openings 39 assigned to an adhesive outlet 16 can herein be assigned feed lines 40, which are arranged at an angle a to the principal direction of delivery H of the adhesive. The angle a is, in particular, an acute angle, which preferably measures between 10 and 25 degrees.

This is evident in FIG. 4, wherein FIG. 4 represents a very schematic, enlarged sectional representation of the lower part, comprising the adhesive outlets 16, of the application head 11 (in a frontal view roughly according to FIG. 1).

In other words, the dried compressed air can pass (in a straight line) out of its protective gas outlet opening 39 at an angle of intersection a to the pass-out direction H of the adhesive (from the adhesive outlet 16). To put it another way: the direct feed lines 40 of the protective gas to the protection outlet openings 39 are arranged and oriented (preferably in opposite directions) at an angle α relative to the (central) direct adhesive feed line 43 to the adhesive outlet opening 16.

FIG. 4 illustrates (the adhesive having been omitted) the predominant velocities of the protective gas 41 in the region of a nozzle outlet or in the region of the adhesive outlet 16: Thus, the compressed air velocity ranges are provided with different hatchings or markings. Here, the faster is the flow velocity in this region, the denser is the hatching or marking.

For instance, it can here be seen that the velocity of the protective gas 41 is highest in the region of the feed lines 40. As soon as the gas makes its way through the protective gas outlet opening 39 into the open, the velocities naturally diminish and basically decrease in all directions with remoteness from the outlets 16, 39.

It is herein of critical importance, however, that the protective gas 41, i.e. the dried compressed air, for instance, forms in the region 36 of an adhesive outlet 16 a curtain, a hood or a blanket or similar, which isolates the adhesive outlet 16 from the moisture of the ambient atmosphere or ambient air 42.

This curtain or hood function is illustrated by the view according to FIG. 5, which shows a section through the application head 11 according to the section line V-V in FIG. 4. According to the view of FIG. 5, it herein becomes clear that the adhesive outlet, which cannot be seen in FIG. 5, is also sufficiently securely laterally isolated, namely by the protective gas 41, from the ambient air 42.

Because the protective gas 41 itself has virtually no significant air moisture, it is thus possible to ensure in total that no moist air can make its way to the adhesive outlet 16. Any adhesive remaining in the adhesive outlet 16 is thus protected from moisture and will not react or harden, so that the adhesive outlet 16 as a whole remains clear.

In respect of FIG. 4, it should finally be pointed out that, in the present illustrative embodiment, four nozzles 15 having respectively an adhesive outlet 16 are represented by way of example. In principle, however, a plurality of nozzles or more than four nozzles, or more than four modules, can of course be employed to form an application head 11. In FIG. 4, but also, for instance, in FIG. 1 or 3, the corresponding components are therefore not universally provided with separate reference symbols. The reference symbols should also however be readily transferable to the parallel nozzles.

Regarding the method according to the invention which is represented in the figures, it should basically be noted that the discharged protective gas 41 represented in FIGS. 4 and 5 is in the illustrative embodiments employed as spraying medium. In the illustrative embodiment, the protective gas 41 is accordingly transported and extracted from the openings 39 both during a production process (i.e. during the discharging of adhesive 12) and during a production stoppage or shutdown. Such a phase is here shown, for instance, by FIGS. 4 and 5, in which, therefore, no transported adhesive, but only an adhesive residue 44, is represented.

During such a pause in production or such a production stoppage, protective gas 41 thus continues to pass out of the application head 11.

In this context, in a method according to the invention, the discharge rate or throughput of protective gas 41 can, however, be throttled. The ulterior motive is here that gas 41 can be saved in those phases in which it is not required as a carrier medium. In these phases, fundamentally less gas 41 is needed to maintain the protection function for the adhesive outlets 16 which is represented in FIGS. 4 and 5.

If the production is then resumed, the throttling can be withdrawn and more protective gas 41 can again be transported and emitted via the openings 39, namely in such magnitude that the carrier medium characteristic of the gas 41 is fulfilled, as is expressed, for instance, in the adhesive filaments 12 represented in FIG. 1.

For this, as shown in FIG. 1, for instance, the aforementioned proportional valve 30 can be employed. The latter can ensure, in particular via an actuation by the control device 18, that the gas outlet into the region 36 of an adhesive outlet 16 (or of all adhesive outlets 16) is reduced for the phases in which a pause in production obtains.

It can be established, however, that in the illustrative embodiment air moisture protection gas is basically always introduced into the region of the adhesive outlet opening 16 or is fed thereto, regardless of whether production is just taking place and whether adhesive is being applied or not.

1. A method for protecting an adhesive delivery apparatus having an adhesive outlet opening through which adhesive is extracted from the adhesive delivery apparatus toward a surface (13) which is to be wetted with the adhesive, which comprises feeding an air moisture protection gas into a region of the adhesive outlet opening.

2. The method as claimed in claim 1, wherein an adhesive delivery apparatus for adhesive of a type which hardens under the addition of air moisture is protected, the adhesive being a polyurethane and/or hot-melt and/or reactive adhesive.

3. The method as claimed in claim 1, wherein the adhesive delivery apparatus is configured as a spraying apparatus for the spraying delivery of the adhesive as a filament, through the use of a spraying medium, the air moisture protection gas being employed as the spraying medium.

4. The method as claimed in claim 1, wherein a dry gas is used as the moisture protection gas.

5. The method as claimed in claim 4, wherein the dry gas passes through a membrane dryer connected upstream thereof, before being used as the moisture protection gas.

6. The method as claimed in claim 1, wherein the moisture protection gas is fed to the region of the adhesive outlet opening when no adhesive is extracted from the adhesive delivery apparatus, such as during a pause in production.

7. The method as claimed in claim 1, wherein the inflow rate of air moisture protection gas into the region of the adhesive outlet opening is switchable and can be throttled, when no adhesive is extracted from the adhesive delivery apparatus, such as during a pause in production.

8. The method as claimed in claim 1, wherein the air moisture protection gas is conducted at an angular offset to a principal direction of delivery of the adhesive, which direction is defined by an orientation of the adhesive outlet opening, into the region of the adhesive outlet opening.

9. The method as claimed in claim 1, wherein the moisture protection gas is conducted into a region of the adhesive outlet opening from at least two directions, forming a dry protective gas curtain around the adhesive outlet opening.

10. An adhesive delivery apparatus, comprising: an adhesive outlet opening through which adhesive is extracted from the delivery apparatus toward a surface which is to be wetted with the adhesive; and a moisture protection gas feed line for feeding a moisture protection gas into a region of the adhesive outlet opening.

11. The method as claimed in claim 4, wherein the dry gas is dried air.

12. The method as claimed in claim 4, wherein the dry gas is a dried inert gas.

13. The method as claimed in claim 4, including a membrane drier.

14. The method as claimed in claim 13, including a filter.

15. The method as claimed in claim 14, wherein the filter is positioned upstream of the membrane drier.

16. The adhesive delivery apparatus of claim 10, further including a gas drier.

17. The adhesive delivery apparatus of claim 16, wherein the gas drier is a membrane drier.

18. The adhesive delivery apparatus of claim 16, further including a filter, wherein the filter is upstream of the gas drier.
